(19) United States
(12) Patent Application Publication
(10) Pub. No.: US 2024/0279126 A1
(43) Pub. Date: Aug. 22, 2024

(54) POLYCRYSTALLINE DIAMOND COMPOSITE SHEET HAVING RIPPLE-SHAPED GRADIENT LAYER AND PREPARATION METHOD THEREOF

(71) Applicants: CENTRAL SOUTH UNIVERSITY, Changsha (CN); SF DIAMOND CO., LTD., ZHENGZHOU (CN)

(72) Inventors: Shaohe ZHANG, Changsha (CN); Linglong RONG, Changsha (CN); Dongpeng ZHAO, Zhengzhou (CN); Xiangwang KONG, Changsha (CN); Jincheng LI, Zhengzhou (CN); Hua GAO, Zhengzhou (CN); Jingjing WU, Changsha (CN); Haijiang FANG, Zhengzhou (CN); Haoyang ZHANG, Changsha (CN)

(73) Assignees: CENTRAL SOUTH UNIVERSITY, Changsha (CN); SF DIAMOND CO., LTD., ZHENGZHOU (CN)

(21) Appl. No.: 18/424,835

(22) Filed: Jan. 28, 2024

(30) Foreign Application Priority Data
Feb. 17, 2023 (CN) 202310126026.X

(51) Int. Cl. C04B 37/02; B28B 1/00; B33Y 10/00; B33Y 80/00; C04B 35/532; C04B 35/634; C04B 35/638

(52) U.S. Cl. CPC C04B 37/021; B28B 1/001; B33Y 80/00; C04B 35/532; C04B 35/63408; C04B 35/6342; C04B 35/63424; C04B 35/638; B33Y 10/00; C04B 2235/427; C04B 2235/5436; C04B 2235/6026; C04B 2235/6562; C04B 2235/6567; C04B 2235/6582; C04B 2235/945; C04B 2237/363; C04B 2237/401; C04B 2237/62

(57) ABSTRACT

The disclosure relates to a polycrystalline diamond composite sheet having a ripple-shaped gradient layer and a preparation method thereof. The polycrystalline diamond composite sheet consists of a cemented carbide substrate, a ripple-shaped gradient layer of a multi-layer structure, and a polycrystalline diamond layer from bottom to top. In the ripple-shaped gradient layer, a content of polycrystalline diamond increases from bottom to top, and a content of cemented carbide decreases from bottom to top. In the ripple-shaped gradient layer, an amplitude of a ripple-shaped structure is 0.2 to 0.6 mm, a wavelength is 1 to 2 mm, a spacing between an upper ripple and a lower ripple of a top layer is set to a gradient of (t/2 to t) mm to t mm from a peak to a trough, and spacings between an upper ripple and a lower ripple of remaining layers are all t mm, wherein t is 0.05 to 0.4.

### CROSS-REFERENCE TO RELATED APPLICATION

This application claims the priority benefit of China application serial no. CN 202310126026.X, filed on Feb. 17, 2023. The entirety of the above-mentioned patent application is hereby incorporated by reference herein and made a part of this specification.

### BACKGROUND

### Technical Field

The disclosure belongs to the technical field of polycrystalline diamond composite sheet preparation, and specifically relates to a polycrystalline diamond composite sheet having a ripple-shaped gradient layer and a preparation method thereof.

### Description of Related Art

The polycrystalline diamond composite sheet is made by sintering a diamond layer and a cemented carbide substrate under a condition of an ultra-high pressure and an ultra-high temperature, which simultaneously has properties of diamond such as a high hardness and a high wear resistance and properties of cemented carbide such as a high strength and an impact toughness and is widely used in fields such as oil drilling, geological drilling, engineering drilling, and mechanical processing. Due to the significant difference in thermal expansion coefficients of diamond and cemented carbide, there is a significant residual stress at the interface between the polycrystalline diamond layer (PCD layer) and the cemented carbide substrate, resulting in failure phenomena of the polycrystalline diamond composite sheet such as delamination between the polycrystalline diamond layer and the cemented carbide substrate.

There are currently two ways to enhance the bonding force at the interface between the PCD layer and the cemented carbide substrate. The first is the non-planar connection technology, which improves the bonding force at the interface and structural shear resistance by designing an irregular interface structure, which is commonly seen as, for example, groove-shaped or zigzag-shaped. The second is to add a gradient transition layer and use the gradient transition method to ease the difference in thermal expansion coefficients of the two materials to reduce a large residual stress.

Both of the above methods have respective flaws and shortcomings thereof. Although changing the interface structure can improve the impact resistance and interface bonding performance, the currently common irregular interface structures generally have local stress concentration phenomena and cannot effectively reduce the residual stress at the interface. Similarly, through disposing the gradient transition layer, the residual stress can be effectively reduced, but conventional gradient transition layers are usually planar connections with a small quantity of layers, which not only cannot effectively improve the bonding strength of the interface, but also the reduction in the residual stress is limited to a certain extent. Therefore, combining the two methods can greatly reduce the failure risk of the composite sheet. However, by the current conventional process for preparing the PDC composite sheet, it is hard to prepare a polycrystalline diamond composite sheet having a complex structure and a large quantity of gradient transition layers.

### SUMMARY

In order to overcome the shortcomings of the existing technology, the first purpose of the disclosure is to provide a polycrystalline diamond composite sheet having a ripple-shaped gradient layer. Through disposing the ripple-shaped gradient layer, the interface bonding strength is improved, the internal residual stress of the composite sheet is reduced, and the phenomenon of delamination between the polycrystalline diamond layer and the cemented carbide substrate during actual use is solved.

The second purpose of the disclosure is to provide a preparation method of a polycrystalline diamond composite sheet having a ripple-shaped gradient layer. The fused deposition modeling (FDM) 3D printing technology is used to realize the preparation of the polycrystalline diamond composite sheet having the ripple-shaped gradient layer.

In order to achieve the above purposes, the disclosure adopts technical solutions as the following.

According to the disclosure, a polycrystalline diamond composite sheet having a ripple-shaped gradient layer is provided. The polycrystalline diamond composite sheet consists of a cemented carbide substrate, a ripple-shaped gradient layer of a multi-layer structure, and a polycrystalline diamond layer from bottom to top. In the ripple-shaped gradient layer, a content of polycrystalline diamond increases from bottom to top, and a content of cemented carbide decreases from bottom to top; and in the ripple-shaped gradient layer, an amplitude of a ripple-shaped structure is 0.2 to 0.6 mm and preferably 0.3 to 0.4 mm, a wavelength is 1 to 2 mm, a spacing between an upper ripple and a lower ripple of a top layer is set to a gradient of (t/2˜t) mm to t mm from a peak to a trough, and spacings between an upper ripple and a lower ripple of remaining layers are all t mm, in which t is 0.05 to 0.4.

The polycrystalline diamond composite sheet according to the disclosure is disposed with the ripple-shaped gradient layer with a cross-section of a multi-layer ripple shape in between, by using a ripple-shaped interface structure, the bonding area of the interface is increased. Also, the interface structure allows the polycrystalline diamond composite sheet to bear stress distribution without directionality, thereby the interface stress is dispersed and the impact resistance is improved. At the same time, the spacing between the upper ripple and the lower ripple of the uppermost gradient layer bonded with the polycrystalline diamond layer gradually changes from the peak to the trough, which improves the local stress concentration phenomenon common in conventional irregular interface structures. In addition, disposing the multi-layer gradient layer can effectively alleviate a large residual stress caused by the difference in thermal expansion coefficients of the polycrystalline diamond layer and the cemented carbide substrate, thereby reducing the quality risk of delamination between the polycrystalline diamond layer and the cemented carbide substrate during actual use.

The inventor found that in order to optimize the performance of the final polycrystalline diamond composite sheet, it is necessary to effectively control the spacing between the upper ripple and the lower ripple. If the spacing between the upper ripple and the lower ripple of any layer is large, causing excessive stress changes between the layers and resulting in the reduction of the strength of the composite sheet. If the spacing between the upper ripple and the lower ripple of any layer is small, the irregular feature is not significant, which is similar to the conventional planar structure, thereby the phenomenon such as the interface being likely to crack occurs.

In a preferred solution, the cemented carbide in the cemented carbide substrate and the ripple-shaped gradient layer is Co—WC, a mass fraction of Co is 5 to 25%, and a mass fraction of WC is 75 to 95%. More preferably, a mass fraction of Co is 13 to 15%, and a mass fraction of WC is 85 to 87%.

In a preferred solution, the ripple-shaped gradient layer is divided into n layers, and the n is 3 to 16. More preferably, the n is 5 to 6. The inventor found that by controlling the quantity of layers within the above range, the performance of the final product is optimal. If the quantity of layers is too many, then the cost increases and the advantage is not significant. If the quantity of layers is too few, the advantage of gradient transition cannot be utilized.

In a preferred solution, in the ripple-shaped gradient layer, a volume fraction of polycrystalline diamond in a bottom layer is 5 to 15%, and then the volume fraction increases by 5 to 30% for each layer from a next bottom layer to the top layer; and a volume fraction of polycrystalline diamond in the top layer is 75 to 95%, a volume fraction of cemented carbide in the bottom layer is 85 to 95%, and then the volume fraction decreases by 5 to 30% for each layer from the next bottom layer to the top layer. More preferably, a volume fraction of polycrystalline diamond in a bottom layer is 10 to 15%, and a volume fraction of polycrystalline diamond in the top layer is 75 to 85%.

The inventor found that in the ripple-shaped gradient layer, the performance of the final polycrystalline diamond composite sheet obtained by gradient changes in the above manner is optimal. However, if the gradient in the volume fraction is unreasonable, then the gradient transition of the material cannot be realized. Also, if a raw material of a certain layer is suddenly increased or decreased, then the residual stress is increased.

In a preferred solution, a top surface of the cemented carbide substrate and a bottom surface of the polycrystalline diamond layer are both ripple-shaped.

According to the disclosure, a preparation method of a polycrystalline diamond composite sheet having a ripple-shaped gradient layer is also provided. A diamond powder and a binder are kneaded and granulated to obtain a polycrystalline diamond layer granular material. A diamond powder, a WC—Co alloy powder, and a binder are kneaded and granulated according to designed components of each layer in the ripple-shaped gradient layer to obtain N groups of ripple-shaped gradient layer granular materials. Then, 3D printing is performed on the polycrystalline diamond layer granular material to obtain a polycrystalline diamond layer green body. PVA (polyvinyl alcohol) and the N groups of ripple-shaped gradient layer granular materials are printed alternately layer by layer by using the PVA (polyvinyl alcohol, molecular formula: [C₂H₄O]n, melting point: 200 to 230° C.) as a support layer material to obtain a ripple-shaped gradient layer green body A having a support structure. The support structure is removed from the ripple-shaped gradient layer green body A having the support structure to obtain a ripple-shaped gradient layer green body B. The ripple-shaped gradient layer green body B and the polycrystalline diamond layer green body are assembled together to obtain a composite green body. The composite green body is degreased to obtain a degreased composite green body. The degreased composite green body and the cemented carbide substrate are assembled together and synthesized under a high temperature and a high pressure to obtain the polycrystalline diamond composite sheet.

In a preferred solution, a particle size of the diamond powder is 0.5 to 100 μm, and a particle size of the WC—Co alloy powder is 0.5 to 150 μm. More preferably, a particle size of the diamond powder is 15 to 50 μm, and a particle size of the WC—Co alloy powder is 25 to 50 μm.

In a preferred solution, a composition of the binder in the polycrystalline diamond layer granular material and the N groups of ripple-shaped gradient layer granular materials is, in terms of a mass percentage, as follows: paraffin wax (PW) 8 to 35%, polymethylmethacrylate (PMMA) 20 to 26%, ethylene-vinyl acetate copolymer (EVA) 20 to 26%, low-density polyethylene (LDPE) 18 to 24%, epoxidized soybean oil (ESO) 3 to 8%, and stearic acid (SA) 1 to 3%. More preferably, a composition of the binder is, in terms of a mass percentage, as follows: paraffin wax (PW) 30 to 33%, polymethylmethacrylate (PMMA) 22 to 24%, ethylene-vinyl acetate copolymer (EVA) 20 to 22%, low-density polyethylene (LDPE) 18 to 20%, epoxidized soybean oil (ESO) 4 to 6%, and stearic acid (SA) 1 to 3%

In the binder of the disclosure, paraffin wax (PW) and epoxidized soybean oil (ESO) are used as filling phases to adjust the wettability, stearic acid (SA) is added as a surfactant, polymethylmethacrylate (PMMA), low-density polyethylene (LDPE), and ethylene-vinyl acetate copolymer (EVA) are added to adjust the strength and viscosity of the binder, and the range of each component is confirmed through extensive experiments. Through using the above-mentioned components of the binder, the granular material formed in the disclosure can ensure the uniformity of the distribution of cemented carbide and diamond powder, thereby the agglomeration is reduced and the quality formed is ensured. The inventor found that the content of each component of the binder should be controlled within a given range, otherwise the printing performance of the granular material is affected. The raw materials in the above-mentioned binder are all commercially available products. Among the raw materials, in paraffin wax, molecular formula is CₙH₂ₙ₊₂ and melting point is 58 to 62° C.; in polymethylmethacrylate, molecular formula is (C₅H₈O₂)ₙ and melting point is 150° C.; in ethylene-vinyl acetate copolymer, molecular formula is (C₂H₄)ₓ(C₄H₆O₂)_{y} and melting point is 90 to 110° C.; in low-density polyethylene, molecular formula is (C₂H₄)ₙ and melting point is 92° C.; in epoxidized soybean oil, molecular formula is C₅₇H₉₈O₁₂ and melting point is 0° C.; and in stearic acid, molecular formula is C₁₈H₃₆O₂ and melting point is 67 to 72° C.

In a preferred solution, in the polycrystalline diamond layer granular material, in terms of a mass ratio, the binder: the diamond powder=1:2 to 20. More preferably, the binder: the diamond powder=1:10 to 15.

In a preferred solution, in the N groups of ripple-shaped gradient layer granular materials, in terms of a mass ratio, the binder: (the diamond powder+the WC—Co alloy powder)=1:2 to 20. More preferably, the binder: (the diamond powder+the WC—Co alloy powder)=1:10 to 15.

In a preferred solution, the diamond powder and the binder are kneaded at 150° C. to 350° C. for 60 to 120 min and then granulated to obtain the polycrystalline diamond layer granular material. More preferably, the diamond powder and the binder are kneaded at 160° C. to 260° C. for 100 to 120 min.

The inventor found that it is crucial to first prepare the polycrystalline diamond layer granular material and then the material is used to perform the fused deposition modeling (FDM) printing technology. If a filament material is made, since the content of the binder in the filament material is higher than the content of the granular material, the ripple-shaped structure of the product is damaged during the degreasing process of forming the composite green body since the content of the binder is high.

In a preferred solution, the diamond powder, the WC—Co alloy powder, and the binder are kneaded at 150° C. to 350° C. for 60 to 120 min according to the designed components of each layer in the ripple-shaped gradient layer and granulated to obtain the N groups of ripple-shaped gradient layer granular materials. More preferably, the diamond powder, the WC—Co alloy powder, and the binder are kneaded at 160° C. to 260° C. for 100 to 120 min.

In the actual operation process of the disclosure, kneading is performed in an internal mixer, and the internal mixed feeding material is obtained and sent to a granulator for granulation. After obtaining the polycrystalline diamond layer granular material and the N groups of ripple-shaped gradient layer granular materials through granulation, models of the ripple-shaped gradient layer, the support layer used to support the ripple-shaped gradient layer, and the polycrystalline diamond layer are respectively established in the computer, and the models are imported into a slicing software for assembly, slicing settings, and printing parameter settings. After the settings are completed, the files are imported into the FDM printer of the granular materials. Then, PVA (polyvinyl alcohol) is used as the support layer material, and the PVA (polyvinyl alcohol), the N groups of ripple-shaped gradient layer granular materials, and the polycrystalline diamond layer granular material are placed at the inlet of the dual-extrusion dual-nozzle FDM printer of the granular materials. The PVA (polyvinyl alcohol) and the N groups of ripple-shaped gradient layer granular materials are printed alternately layer by layer to obtain the ripple-shaped gradient layer green body A having the supporting structure, and the polycrystalline diamond layer granular material is printed to obtain the polycrystalline diamond layer green body.

In a preferred solution, during the process of performing 3D printing on the polycrystalline diamond layer granular material to obtain the polycrystalline diamond layer green body, a diameter of a nozzle used is 0.2 to 4 mm, a layer height is 0.05 to 2 mm, an extrusion rate is 2 to 200 mm/s, and an extrusion flow rate is 100 to 180%. More preferably, a diameter of a nozzle used is 0.4 to 0.6 mm, a layer height is 0.05 to 1 mm, an extrusion rate is 35 to 40 mm/s, and an extrusion flow rate is 120 to 130%.

In a preferred solution, during the process of printing the PVA (polyvinyl alcohol) and the N groups of ripple-shaped gradient layer granular materials alternately layer by layer to obtain the ripple-shaped gradient layer green body A having the support structure, when printing the PVA, a diameter of a nozzle used is 0.4 to 0.8 mm, a layer height is 0.2 to 0.6 mm, an extrusion rate is 100 to 200 mm/s, and an extrusion flow rate is 120 to 180%, when printing the N groups of ripple-shaped gradient layer granular materials, a diameter of a nozzle used is 0.2 to 4 mm, a layer height is 0.05 to 2 mm, an extrusion rate is 2 to 200 mm/s, and an extrusion flow rate is 100 to 180%. More preferably, when printing the PVA, a diameter of a nozzle used is 0.4 to 0.8 mm, a layer height is 0.4 to 0.6 mm, an extrusion rate is 120 to 150 mm/s, and an extrusion flow rate is 130 to 150%, when printing the N groups of ripple-shaped gradient layer granular materials, a diameter of a nozzle used is 0.4 to 0.6 mm, a layer height is 0.05 to 0.1 mm, an extrusion rate is 35 to 40 mm/s, and an extrusion flow rate is 120 to 130%.

In a preferred solution, the ripple-shaped gradient layer green body A having the support structure is placed in a water bath at 75 to 90° C. and through which the support structure is removed to obtain the ripple-shaped gradient layer green body B.

In a preferred solution, the degreasing is performed in a hydrogen atmosphere, a hydrogen flow rate during the degreasing is 3 to 5 L/min, and a temperature rising process during the degreasing is as the following: first, raising a temperature from a room temperature to 100 to 150° C. at a temperature rise rate of 5 to 10° C./min and maintaining for 75 to 100 min; next, raising the temperature to 350 to 400° C. at a temperature rise rate of 2 to 6° C./min and maintaining for 45 to 60 min; and then raising the temperature to 500 to 550° C. at a temperature rise rate of 1 to 5° C./min and maintaining for 90 to 120 min.

In the thermal degreasing process of the disclosure, based on the difference in the pyrolysis temperature range of different components of the binder, the temperature is raised in a gradient manner for step-by-step degreasing, so as to ensure the integrity of the green body and the elimination of the binder in the green body, thereby defects of the degreasing is avoided.

In a preferred solution, a pressure of the synthesizing under the high temperature and the high pressure is 2 to 8.5 GPa, a temperature of the synthesizing under the high temperature and the high pressure is 1200 to 1850° C., and a time of the synthesizing under the high temperature and the high pressure is 300 to 1000 seconds. More preferably, a pressure of the synthesizing under the high temperature and the high pressure is 5.5 to 8.5 GPa, a temperature of the synthesizing under the high temperature and the high pressure is 1500 to 1850° C., and a time of the synthesizing under the high temperature and the high pressure is 500 to 1000 seconds.

### Beneficial Effects

The disclosure provides a ripple-shaped gradient structure polycrystalline diamond composite sheet. In the polycrystalline diamond composite sheet, by using a ripple-shaped interface structure, the bonding area of the interface is increased. Also, the interface structure allows the polycrystalline diamond composite sheet to bear stress distribution without directionality, thereby the interface stress is dispersed and the impact resistance is improved. At the same time, the spacing between the upper ripple and the lower ripple of the uppermost gradient layer bonded with the polycrystalline diamond layer gradually changes from the peak to the trough, which improves the local stress concentration phenomenon common in conventional irregular interface structures. In addition, disposing the multi-layer gradient layer can effectively alleviate a large residual stress caused by the difference in thermal expansion coefficients of the polycrystalline diamond layer and the cemented carbide substrate, thereby reducing the quality risk of delamination between the polycrystalline diamond layer and the cemented carbide substrate during actual use.

The disclosure uses fused deposition modeling (FDM) 3D printing technology to break the limitations of conventional processes for preparing the polycrystalline diamond composite sheet having the complex interface and the multi-layer gradient layer structure, and the preparation of the polycrystalline diamond composite sheet having the ripple-shaped gradient layer is realized. Multiple FDM printers of the granular materials are used to print different structural layer green bodies respectively. After the quality inspection of the different green bodies passes, assembling, degreasing, and sintering are performed on the green bodies to achieve assembly line production and precise quality control, which greatly improves the production efficiency and the rate of qualified products of the polycrystalline diamond composite sheet.

### BRIEF DESCRIPTION OF THE DRAWINGS

FIG. 1 is a schematic diagram of a polycrystalline diamond composite sheet having a ripple-shaped gradient layer.

FIG. 2 is a schematic diagram of a cross-sectional structure along a diameter of the polycrystalline diamond composite sheet having the ripple-shaped gradient layer.

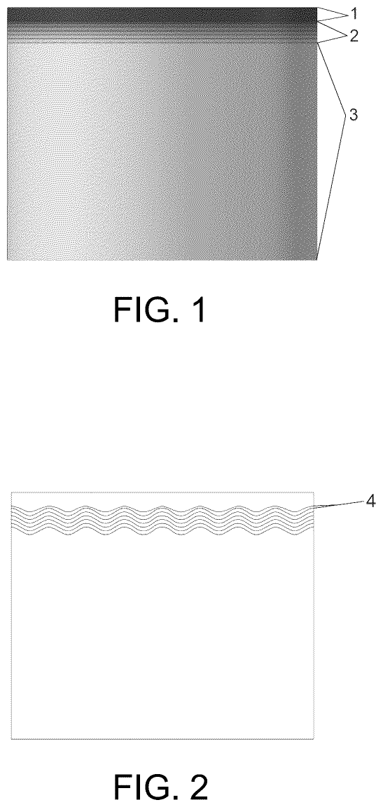

In FIG. 1 and FIG. 2, reference numeral 1 is a polycrystalline diamond layer, reference numeral 2 is a ripple-shaped gradient layer, reference numeral 3 is a cemented carbide substrate, and reference numeral 4 is an uppermost gradient layer.

### DESCRIPTION OF THE EMBODIMENTS

### Example 1

The polycrystalline diamond composite sheet having a ripple-shaped gradient layer includes three parts, which are a polycrystalline diamond layer, a ripple-shaped gradient layer, and a cemented carbide substrate. The dimension of diameter×height of the polycrystalline diamond composite sheet of the design model 1613 is 16.00 mm×13.20 mm. The amplitude of the ripple-shaped structure (except the upper ripple of the uppermost layer of the gradient layer) is 0.4 mm and the wavelength is 1 mm. The height of the bonding interface between the cemented carbide substrate and the gradient layer from the peak to the trough is 0.4 mm, in which the peak height is 0.2 mm, and the height of the cemented carbide substrate from the peak to the lower bottom surface is 11.2 mm. A spacing between an upper ripple and a lower ripple of an uppermost layer of the gradient layer is set with a gradient of 0.1 mm to 0.2 mm from the peak to the trough, and the spacing between the upper ripple and the lower ripple of each layer except the uppermost layer is 0.2 mm. The height of the bonding interface between the polycrystalline diamond layer and the gradient layer from the peak to the trough is 0.3 mm, in which the peak height is 0.1 mm, the wavelength is 1 mm, and the height of the polycrystalline diamond layer from the peak to the top surface is 0.9 mm.

The cemented carbide substrate is made of YG15 (WC-15 wt % Co) alloy, in which the mass fractions of WC and Co are 85% for WC and 15% for Co. 6 ripple-shaped gradient layers are disposed. The volume contents of diamond in each layer from bottom to top are 10%, 25%, 40%, 55%, 70%, and 85% respectively, and the corresponding volume contents of YG15 in each gradient layer are 90%, 75%, 60%, 45%, 30%, and 15% respectively. The particle size of the YG15 pre-alloyed powder is 25 to 30 μm, and the particle size of the diamond powder is 15 to 20 μm.

The preparation process thereof is as the following.

Step 1: An appropriate amount of the diamond powder and the YG15 pre-alloyed powder are taken according to the set proportions of the polycrystalline diamond layer and each gradient layer respectively and kneaded. The mixture is placed into an internal mixer for internal mixing at 260° C. A certain proportion of a designated binder is added. The mass ratio of the designated binder to the powder is 1:15, in which the mass fractions of PW, PMMA, EVA, LDPE, ESO, and stearic acid (SA) are 30%, 23%, 22%, 20%, 4%, and 1% respectively. The internal mixing is performed for 110 min, and then the internal mixed feeding material is sent to a granulator for granulation to obtain the material for forming.

Step 2: Models of the 6-layer gradient layer, the polycrystalline diamond layer, and the support structure of the gradient layer are established in the computer. The model files are assembled and sliced by using the slicing software. The final 8 slicing files are imported into the FDM printer of the granular materials.

Step 3: The material for forming, the water-soluble support material PVA (polyvinyl alcohol) are placed into the two inlets of the dual-extrusion dual-nozzle FDM printer of the granular materials. After printing, a gradient layer green body having a support structure and a polycrystalline diamond layer green body are obtained. Printing parameters of the particle are set as the following. For printing the material for forming, a diameter of a nozzle used is 0.4 mm, a layer height is 0.1 mm, an extrusion rate is 35 mm/s, and an extrusion flow rate is 120%. For printing the PVA, a diameter of a nozzle used is 0.8 mm, a layer height is 0.4 mm, an extrusion rate is 120 mm/s, and an extrusion flow rate is 130%.

Step 4: The gradient layer green body having the support structure is placed in a beaker filled with water for heating in a water bath at 80° C. to dissolve the support. After the support is dissolved, the gradient layer green body with the support being removed is obtained.

Step 5: The printed green bodies of sheets and layers are sequentially placed in a metal cup and put into a degreasing furnace for degreasing. Parameters of the degreasing process are as the following. In a first stage, a temperature is raised to 150° C. at a temperature rise rate of 5° C./min and maintained for 75 min. In a second stage, the temperature is raised to 400° C. at a temperature rise rate of 4° C./min and maintained for 50 min. In a third stage, the temperature is raised to 550° C. at a temperature rise rate of 2° C./min and maintained for 100 min. The atmosphere is hydrogen and the hydrogen flow rate is 5 L/min.

Step 6: The degreased sample and the cemented carbide substrate are placed into a six-sided hydraulic top press, the pressure is raised to 5.5 GPa, the temperature is raised to 1500° C., and the pressure and temperature are maintained for 600 seconds. Afterward, the heating is stopped and the pressure is reduced so that the device temperature reaches the room temperature. After the pressure drops to the standard atmosphere, the polycrystalline diamond composite sheet having the ripple-shaped gradient layer is obtained and taken out from the six-sided hydraulic top press.

### Example 2

The polycrystalline diamond composite sheet having a ripple-shaped gradient layer includes three parts, which are a polycrystalline diamond layer, a ripple-shaped gradient layer, and a cemented carbide substrate. The dimension of diameter×height of the polycrystalline diamond composite sheet of the design model 1308 is 13.00 mm×8.00 mm. The amplitude of the ripple-shaped structure (except the upper ripple of the uppermost layer of the gradient layer) is 0.3 mm and the wavelength is 1 mm. The height of the bonding interface between the cemented carbide substrate and the gradient layer from the peak to the trough is 0.3 mm, in which the peak height is 0.15 mm, and the height of the cemented carbide substrate from the peak to the lower bottom surface is 5.5 mm. A spacing between an upper ripple and a lower ripple of an uppermost layer of the gradient layer is set with a gradient of 0.3 mm to 0.4 mm from the peak to the trough, and the spacing between the upper ripple and the lower ripple of each layer except the uppermost layer is 0.4 mm. The height of the bonding interface between the polycrystalline diamond layer and the gradient layer from the peak to the trough is 0.2 mm, in which the peak height is 0.05 mm, the wavelength is 1 mm, and the height of the polycrystalline diamond layer from the peak to the top surface is 0.6 mm.

The cemented carbide substrate is made of YG13 (WC-13 wt % Co) alloy, in which the mass fractions of WC and Co are 87% for WC and 13% for Co. 5 gradient layers are disposed. The volume contents of diamond in each layer from bottom to top are 15%, 30%, 45%, 60%, and 75% respectively, and the corresponding volume contents of YG13 in each gradient layer are 85%, 70%, 55%, 40%, and 25% respectively. The particle size of the YG13 pre-alloyed powder is 40 to 50 μm, and the particle size of the diamond powder is 40 to 50 μm.

The preparation process thereof is as the following.

Step 1: An appropriate amount of the diamond powder and the YG13 pre-alloyed powder are taken according to the set proportions of the polycrystalline diamond layer and each gradient layer respectively and kneaded. The mixture is placed into an internal mixer for internal mixing at 160° C. A certain proportion of a designated binder is added. The mass ratio of the designated binder to the powder is 1:10, in which the mass fractions of PW, PMMA, EVA, LDPE, ESO, and stearic acid (SA) are 31%, 22%, 22%, 18%, 6%, and 1% respectively. The internal mixing is performed for 100 min, and then the internal mixed feeding material is sent to a granulator for granulation to obtain the material for forming.

Step 2: Models of the 5-layer gradient layer, the polycrystalline diamond layer, and the support structure of the gradient layer are established in the computer. The model files are assembled and sliced by using the slicing software. The final 7 slicing files are imported into the FDM printer of the granular materials.

Step 3: The material for forming, the water-soluble support material PVA (polyvinyl alcohol) are placed into the two inlets of the dual-extrusion dual-nozzle FDM printer of the granular materials. After printing, a gradient layer green body having a support structure and a polycrystalline diamond layer green body are obtained. Printing parameters of the particle are set as the following. For printing the material for forming, a diameter of a nozzle used is 0.6 mm, a layer height is 0.1 mm, an extrusion rate is 40 mm/s, and an extrusion flow rate is 130%. For printing the PVA, a diameter of a nozzle used is 0.8 mm, a layer height is 0.6 mm, an extrusion rate is 150 mm/s, and an extrusion flow rate is 150%.

Step 4: The gradient layer green body having the support structure is placed in a beaker filled with water for heating in a water bath at 80° C. to dissolve the support. After the support is dissolved, the gradient layer green body with the support being removed is obtained.

Step 5: The printed green bodies of sheets and layers are sequentially placed in a metal cup and put into a degreasing furnace for degreasing. Parameters of the degreasing process are as the following. In a first stage, a temperature is raised to 150° C. at a temperature rise rate of 8° C./min and maintained for 90 min. In a second stage, the temperature is raised to 400° C. at a temperature rise rate of 4° C./min and maintained for 60 min. In a third stage, the temperature is raised to 500° C. at a temperature rise rate of 2° C./min and maintained for 100 min. The atmosphere is hydrogen (H2) and the hydrogen flow rate is 4 L/min.

Step 6: The degreased sample and the cemented carbide substrate are placed into a six-sided hydraulic top press, the pressure is raised to 5.5 GPa, the temperature is raised to 1500° C., and the pressure and temperature are maintained for 500 seconds. Afterward, the heating is stopped and the pressure is reduced so that the device temperature reaches the room temperature. After the pressure drops to the standard atmosphere, the polycrystalline diamond composite sheet having the ripple-shaped gradient layer is obtained and taken out from the six-sided hydraulic top press. The comparison results between the residual stress of the composite sheet in the above embodiments and the maximum residual tensile stress of an ordinary composite sheet are shown in Table 1 below. The ordinary composite sheet is made by directly connecting the polycrystalline diamond layer and the cemented carbide substrate in a planar form.

TABLE 1
Finite element analysis results of the maximum
residual tensile stress in the composite sheet

| | Maximum tensile stress | | |
|---|---|---|---|
| | Radial | Axial | Shear |
| | stress (GPa) | stress (GPa) | stress (GPa) |
| Ordinary composite sheet | 1.52 | 1.46 | 1.02 |
| Example 1 | 0.75 | 0.35 | 0.32 |
| Example 2 | 0.8 | 0.42 | 0.38 |

### Comparative Example

In the comparative examples, merely certain experimental parameters are changed, and other experimental conditions are the same as in Example 1. The comparison results obtained are shown in Table 2 below.

TABLE 2
Comparative experiment results table

| Serial | | | |
|---|---|---|---|
| number | Changed condition | Parameter after change | Comparison result |
| 1 | Quantity of gradient | The volume contents of | The maximum radial tensile |
| | layers from 6 layers | diamond in 2 layers from | stress increases to 1.2 GPa, the |
| | to 2 layers | bottom to top are 25% and | maximum axial tensile stress |
| | | 70% respectively; the | increases to 0.85 GPa, and the |
| | | spacing between the upper | maximum shear tensile stress |
| | | ripple and the lower ripple | increases to 0.82 GPa |
| | | of the upper layer of the | |
| | | gradient layer is set with a | |
| | | gradient of 0.1 mm to 0.2 | |
| | | mm from the peak to the | |
| | | trough, and the spacing | |
| | | between the upper ripple | |
| | | and the lower ripple of the | |
| | | lower layer of the gradient | |
| | | layer is 0.2 mm. The | |
| | | height of the bonding | |
| | | interface between the | |
| | | polycrystalline diamond | |
| | | layer and the gradient layer | |
| | | from the peak to the trough | |
| | | is 0.3 mm, in which the | |
| | | peak height is 0.1 mm, and | |
| | | the height of the | |
| | | polycrystalline diamond | |
| | | layer from the peak to the | |
| | | top surface is 1.7 mm. | |
| 2 | Spacing between | The spacing between the | The maximum axial tensile stress |
| | the upper ripple and | upper ripple and the lower | increases to 0.68 GPa, and the |
| | the lower ripple of | ripple of the uppermost | maximum shear tensile stress |
| | the uppermost layer | layer of the gradient layer is | increases to 0.63 GPa |
| | of the gradient layer | 0.2 mm. The height of the | |
| | as the same as that | bonding interface between | |
| | of the rest layers of | the polycrystalline diamond | |
| | the gradient layer | layer and the gradient layer | |
| | | from the peak to the trough | |
| | | turns to 0.4 mm, in which | |
| | | the peak height is 0.2 mm, | |
| | | and the height of the | |
| | | polycrystalline diamond | |
| | | layer from the peak to the | |
| | | top surface turns to 0.8 mm. | |
| 3 | The mass ratio of | The mass ratio of the | The green body is collapsed after |
| | the designated | designated binder to powder | the degreasing, and the ripple- |
| | binder to powder | is 1:1 for kneading, and the | shaped structure is destroyed. |
| | from 1:15 to 1:1 | mass of the binder used in | |
| | | Example 1 is increased. | |
| 4 | No more adding | In each component of the | It is difficult to granulate through |
| | epoxidized soybean | binder, in terms of a mass | the granulator. It is powdery and |
| | oil (ESO) | ratio, | difficult to pass through the |
| | | PW:PMMA:EVA:LDPE:SA | nozzle of the printer. |
| | | is 30:23:22:20:1 | |
| 5 | Water bath heating | 60° C. | The speed of the PVA removal is |
| | temperature | | slow and the PVA remains. |

What is claimed is:

1. A polycrystalline diamond composite sheet having a ripple-shaped gradient layer, wherein
the polycrystalline diamond composite sheet consists of a cemented carbide substrate, a ripple-shaped gradient layer of a multi-layer structure, and a polycrystalline diamond layer from bottom to top,
in the ripple-shaped gradient layer, a content of polycrystalline diamond increases from bottom to top, and a content of cemented carbide decreases from bottom to top, and
in the ripple-shaped gradient layer, an amplitude of a ripple-shaped structure is 0.2 to 0.6 mm, a wavelength is 1 to 2 mm, a spacing between an upper ripple and a lower ripple of a top layer is set to a gradient of (t/2 to t) mm to t mm from a peak to a trough, and spacings between an upper ripple and a lower ripple of remaining layers are all t mm, wherein t is 0.05 to 0.4.

2. The polycrystalline diamond composite sheet having the ripple-shaped gradient layer according to claim 1, wherein the cemented carbide substrate and the cemented carbide in the ripple-shaped gradient layer is Co—WC, a mass fraction of Co is 5 to 25%, and a mass fraction of WC is 75 to 95%.

3. The polycrystalline diamond composite sheet having the ripple-shaped gradient layer according to claim 1, wherein the ripple-shaped gradient layer is divided into n layers, and the n layers is 3 to 16 layers.

4. The polycrystalline diamond composite sheet having the ripple-shaped gradient layer according to claim 1, wherein in the ripple-shaped gradient layer,
a volume fraction of the polycrystalline diamond in a bottom layer is 5 to 15%, and then the volume fraction increases by 5 to 30% for each layer from a next bottom layer to the top layer;
a volume fraction of the polycrystalline diamond in the top layer is 75 to 95%; and
a volume fraction of the cemented carbide in the bottom layer is 85 to 95%, and then the volume fraction decreases by 5 to 30% for each layer from the next bottom layer to the top layer.

5. The polycrystalline diamond composite sheet having the ripple-shaped gradient layer according to claim 1, wherein a top surface of the cemented carbide substrate and a bottom surface of the polycrystalline diamond layer are both ripple-shaped.

6. A preparation method of the polycrystalline diamond composite sheet having the ripple-shaped gradient layer according to claim 1, comprising:
kneading and granulating a diamond powder and a binder to obtain a polycrystalline diamond layer granular material;
kneading and granulating a diamond powder, a WC—Co alloy powder, and a binder according to designed components of each layer in the ripple-shaped gradient layer to obtain N groups of ripple-shaped gradient layer granular materials;
performing 3D printing on the polycrystalline diamond layer granular material to obtain a polycrystalline diamond layer green body;
printing polyvinyl alcohol (PVA) and the N groups of ripple-shaped gradient layer granular materials alternately layer by layer by using the PVA as a support layer material to obtain a ripple-shaped gradient layer green body A having a support structure;
removing the support structure from the ripple-shaped gradient layer green body A having the support structure to obtain a ripple-shaped gradient layer green body B;
assembling the ripple-shaped gradient layer green body B and the polycrystalline diamond layer green body together to obtain a composite green body;
degreasing the composite green body to obtain a degreased composite green body; and
assembling the degreased composite green body and the cemented carbide substrate together and then synthesizing under a high temperature and a high pressure to obtain the polycrystalline diamond composite sheet.

7. The preparation method of the polycrystalline diamond composite sheet having the ripple-shaped gradient layer according to claim 6, wherein a particle size of the diamond powder is 0.5 to 100 μm, and a particle size of the WC—Co alloy powder is 0.5 to 150 μm;
a composition of the binder in the polycrystalline diamond layer granular material and the N groups of ripple-shaped gradient layer granular materials is, in terms of a mass percentage, as follows:
paraffin wax 8 to 35%,
polymethylmethacrylate 20 to 26%,
ethylene-vinyl acetate copolymer 20 to 26%,
low-density polyethylene 18 to 24%,
epoxidized soybean oil 3 to 8%, and
stearic acid 1 to 3%;
in the polycrystalline diamond layer granular material, in terms of a mass ratio, the binder: the diamond powder=1:2 to 20; and
in the N groups of ripple-shaped gradient layer granular materials, in terms of a mass ratio, the binder: (the diamond powder+the WC—Co alloy powder)=1:2 to 20.

8. The preparation method of the polycrystalline diamond composite sheet having the ripple-shaped gradient layer according to claim 6, wherein
in an operation of kneading and granulating the diamond powder and the binder to obtain the polycrystalline diamond layer granular material, the kneading is performed at 150° C. to 350° C. for 60 to 120 min; and
in an operation of kneading and granulating the diamond powder, the WC—Co alloy powder, and the binder according to the designed components of each layer in the ripple-shaped gradient layer to obtain the N groups of ripple-shaped gradient layer granular materials, the kneading is performed at 150° C. to 350° C. for 60 to 120 min.

9. The preparation method of the polycrystalline diamond composite sheet having the ripple-shaped gradient layer according to claim 6, wherein in an operation of performing 3D printing on the polycrystalline diamond layer granular material to obtain the polycrystalline diamond layer green body, a diameter of a nozzle used is 0.2 to 4 mm, a layer height is 0.05 to 2 mm, an extrusion rate is 2 to 200 mm/s, and an extrusion flow rate is 100 to 180%; and
in an operation of printing the PVA and the N groups of ripple-shaped gradient layer granular materials alternately layer by layer to obtain the ripple-shaped gradient layer green body A having the support structure, in response to printing the PVA, a diameter of a nozzle used is 0.4 to 0.8 mm, a layer height is 0.2 to 0.6 mm, an extrusion rate is 100 to 200 mm/s, and an extrusion flow rate is 120 to 180%, in response to printing the N groups of ripple-shaped gradient layer granular materials, a diameter of a nozzle used is 0.2 to 4 mm, a layer height is 0.05 to 2 mm, an extrusion rate is 2 to 200 mm/s, and an extrusion flow rate is 100 to 180%.

10. The preparation method of the polycrystalline diamond composite sheet having the ripple-shaped gradient layer according to claim 6, wherein in an operation of degreasing, the degreasing is performed in a hydrogen atmosphere, a hydrogen flow rate during the degreasing is 3 to 5 L/min, and a temperature rising process during the degreasing is as the following: first, raising a temperature from a room temperature to 100 to 150° C. at a temperature rise rate of 5 to 10° C./min and maintaining for 75 to 100 min; next, raising the temperature to 350 to 400° C. at a temperature rise rate of 2 to 6° C./min and maintaining for 45 to 60 min; and then raising the temperature to 500 to 550° C. at a temperature rise rate of 1 to 5° C./min and maintaining for 90 to 120 min;
a pressure of the synthesizing under the high temperature and the high pressure is 2 to 8.5 GPa, a temperature of the synthesizing under the high temperature and the high pressure is 1200 to 1850° C., and a time of the synthesizing under the high temperature and the high pressure is 300 to 1000 seconds.
